(19) United States
(12) Patent Application Publication
(10) Pub. No.: US 2011/0048824 A1
(43) Pub. Date: Mar. 3, 2011

(54) HEATER FOR ELECTRIC CAR

(76) Inventor: Gary Starr, Santa Rosa, CA (US)

(21) Appl. No.: 12/550,323

(22) Filed: Aug. 28, 2009

(51) Int. Cl. B60K 7/00

(52) U.S. Cl. 180/65.51

(57) ABSTRACT

An electric vehicle includes a frame having a cab; a plurality of hub wheel motors mounted to the frame, each hub wheel motor rotating a wheel; and a heater and a fan thermally coupled to the cab, wherein the heater has an independent fuse to prevent a heater problem from shutting down the electric vehicle.

### BACKGROUND

Car heaters are used to warm the interior of a car during cold season and to defrost/defog windows if needed. FIG. 1 shows an exemplary prior art system for heating the interior of a vehicle. Conventional car heaters have three main parts: the cooling system, the heater core and the blower fan and duct system.

Conventional internal combustion vehicles come with a cooling system with a radiator, hoses, coolant and water. The coolant in the block heats up, until it becomes hot enough for the thermostat to open. Once the thermostat opens, the water flows through the radiator. The radiator consists of tubes that make multiple passes and has aluminum fins which cool the passing air. The average water temperature is 200 degrees or maybe higher. This heat is more than enough to heat the whole passenger compartment of a vehicle. This system is pressurized to raise the boiling point of water, allowing the car or vehicle to run hotter than 200 degrees, without boiling over. The coolant travels toward the firewall of the vehicle through heater hoses. Heater hoses are smaller and thicker than radiator hoses. The coolant is directed into the heater core directly from the water pump of the engine. Then, it passes through the heater core. This heater core is designed like a tiny radiator with tubes and fins for cooling. This is usually located behind the firewall and above the area where passengers place their legs. The coolant flow is generally as follows: The coolant is picked up at about mid-engine head and then is routed through an aluminum intake manifold. The coolant passes out of the aluminum intake manifold through an outlet and is then routed through an automatic choke and finally by metal tubing and rubber hose to the heater core. The remaining heat in the coolant is then dissipated, and the coolant is returned to the engine water pump by way of metal tubing and rubber hose. As a result of this coolant circulation arrangement, the coolant which is supplied to the heater core already has had a substantial amount of heat dissipated from it. Hot air is created by the coolant in the heater core. This air is then blown through the air duct system of the vehicle by the blower fan. The blower fan has adjustable speeds to satisfy the needs of the passengers and driver at the time. The end of each duct is located where it enters the passenger compartment. These ends have vents that open and close to let more or less hot air.

In a parallel trend, the rising cost of oil and global warming indications have sensitized manufacturers and consumers to the need to be energy efficient and environmentally responsible. As a result, modern electric cars are becoming popular again. One type of electric car provides a hub wheel motor in each wheel. The advantage of this design is that no additional transmission system is needed, thereby increasing the efficiency of the drive system. However, it is difficult to capture heat from the electric hub wheel motors to warm up the cab or defrost the wind shield.

### SUMMARY

In one aspect, an electric vehicle includes a frame having a cab; a plurality of hub wheel motors mounted to the frame, each hub wheel motor rotating a wheel; and a heater and a fan thermally coupled to the cab, wherein the heater has an independent fuse to prevent a heater problem from shutting down the electric vehicle.

Implementations of the above aspect can include one or more of the following. The fan can provide heat to the cab through a defrost vent, a driver vent, and a passenger vent. A battery voltage sensor can be used to sense battery voltage to shut down the heater in case of low battery. A cabin temperature sensor can be used to adjust cab temperature to a desired range. A battery temperature sensor can be used to detect excessive current drawing by the heater and other electrical/electronics in the vehicle that can damage the battery. A secondary battery can be provided to provide independent power to the heater so that the main battery can be focused on propulsion power requirements. A solar cell can be provided to recharge the main or secondary battery or to power the heater. The heater includes a heating element that converts electricity into heat through Joule heating. The heating elements can be a Nichrome 80/20 (80% nickel, 20% chromium) wire, ribbon, or strip. In another embodiment, the heating element can have a Positive Thermal Coefficient of resistance.

In another aspect, a method for operating an electric vehicle includes providing a plurality of hub wheel motors to a frame with a cab, each hub wheel motor rotating a wheel; and heating the cab using an electric heater with an independent fuse to prevent a heater problem from shutting down the electric vehicle.

Advantages of the system may include one or more of the following. The electric heater provides a highly efficient, rapid warming system for vehicle occupants. The system can be programmed to come on whenever the user wants, the electric heater passes their warmth

The system can preheat the cabin to normal operating temperature, de-mist and defrost the windows and preheat the car's interior, all with the engine switched off. In cold environments, the user can remotely turn on the heater to avoid scraping ice and struggling with steamed-up windows. The timer on the dashboard can be used program when the user wants the heater to start so that, by the time the user drives off, the windscreens and windows are thawed, the temperature inside is nice and warm and the engine is warmed up and ready to go. The system also enables the user to keep the temperature constant even when the electric hub wheel motor or engine is off due to traffic jam. The system enables driving in winter to be safer by preventing windows from steaming up and providing excellent all-round visibility.

### BRIEF DESCRIPTION OF THE DRAWINGS

FIG. 1 shows an exemplary conventional car heater system.

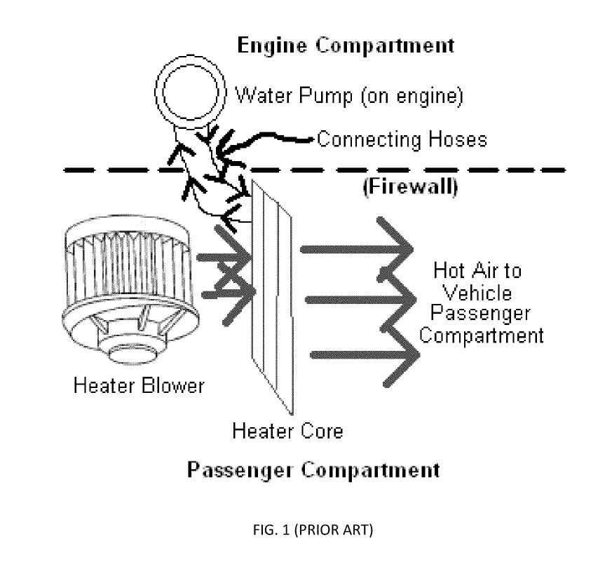

FIG. 2A is a block diagram of the vehicle heater.

FIG. 2B is a block diagram showing high voltage control of a vehicle heater.

FIG. 3 shows an exemplary heater with housing and cab duct outputs.

FIG. 4 shows an exemplary electric heater/fan used in an electric vehicle with hub wheel motors.

FIG. 5 shows an exemplary environmentally friendly vehicle control system.

### DESCRIPTION

The following description of various disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

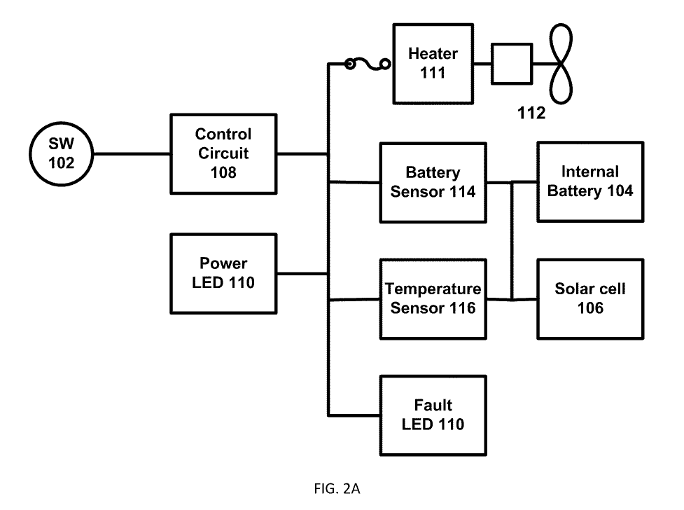

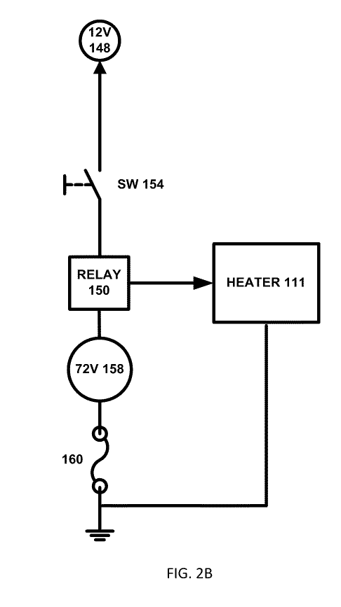

FIG. 2A is a block diagram of the vehicle heater of the present invention. The power is supplied to a heater activate/deactivate circuit 108 from the car battery, not shown, when a switch 102 is placed in the on position. The switch 102 can be a 3 way switch to turn on only heater, only fan, or both heater and fan. Alternatively, the switch 102 can provide the user with a fine grain control of the fan speed to precisely adjust the cabin temperature. Power is also supplied by a battery 104 within the housing when the switch connects the battery 104 to the heater control circuit 108. The control circuit 108 can turn on a heater 111 and/or a fan 112. Additionally, a solar panel 106 can directly power the heater 111 and the fan 112 or the solar panel can recharge the internal battery 104. When power is supplied to the heater activate/deactivate circuit 108 the power indicator light 110 and the heater 111 and fan 112 are turned on. The fan 112 is adapted to generate a flow of air through vents in a passenger compartment of the vehicle only during the receipt of a voltage. The heater 112 includes a heating element or a coil assembly situated in the ventilation system downwind of the fan 112.

The battery sensor 114 and temperature sensor 116 constantly monitor the battery power of the internal battery 104 and car battery and the temperature of the outside air, respectively. When either the battery power gets too low or the temperature gets too high the sensors 114 or 116 causes an indicator light 118 to be turned on to inform the user of a problem. To protect the car and heater 111, the heater 111 has its own fuse. Thus, when the heater 111 draws too much power, the heater fuse will trip to shut down the heater 111 without shutting down the rest of the vehicle. The fuse can be a time delayed fuse in one embodiment.

In one embodiment, the vehicle has a main battery pack that powers the entire vehicle as well as a low voltage auxiliary battery pack. In this embodiment, the heating coil of the heater 111 receives voltage from the main large battery pack. The main pack can supply voltages that can be as low as 36 volts or as high as 360 volts or any suitable voltages. The heater fan 112 may be powered by either a 12 volt auxilliary battery, or a power converter such as a dc to dc converter, or the main battery pack. The heater 111 has a heating element that converts electricity into heat through the process of Joule heating. Electric current through the element encounters resistance, resulting in heating of the element. In one embodiment, the heating elements can use Nichrome 80/20 (80% nickel, 20% chromium) wire, ribbon, or strip. Nichrome 80/20 has a relatively high resistance and forms an adherent layer of chromium oxide when it is heated for the first time. Material beneath the wire will not oxidize, preventing the wire from breaking or burning out. Alternatively, a resistance wire can be used, and the wire may be wire or ribbon, straight or coiled. The wires can be Kanthal (FeCrAl) wires, Nichrome 80/20 wire and strip or Cupronickel (CuNi) alloys for low temperature heating.

In another embodiment, the heating element can be a PTC ceramic which has a Positive Thermal Coefficient of resistance. The PTC ceramics (often barium titanate and lead titanate composites) has a highly nonlinear thermal response, so that it becomes extremely resistant above a composition-dependent threshold temperature. This behavior causes the material to act as its own thermostat, since current passes when it is cool, and does not when it is hot.

Other embodiments can use screen-printed metal-ceramic tracks deposited on ceramic insulated metal (generally steel) plates. Tubular (sealed element) can also be used, where a fine coil of Nickel chrome wire in a insulating binder (MgO, aluminia powder), sealed inside a tube made of stainless steel or brass. In another embodiment, the heater 111 can be a heat lamp—a high-powered incandescent lamp usually run at less than maximum power to radiate mostly infrared instead of visible light.

In one embodiment, the processor keeps track of time by using a dedicated clock/timer chip or alternatively by internally counting clock pulses and translating the clock pulses to seconds, minutes, and hours. The user can provide instruction to the processor to turn on the heater at a predetermined time and duration to provide deicing/defrosting operation to the wind shield. The user can also specify the cabin temperature to be maintained. Thus, if the user plans to drive at 8 am, then the user can program the heater to be turned on at 7:50 to decide/defrost and to warm the cab temperature so that the vehicle is ready for use at 8 am.

In one embodiment, the heater 111 and fan 112 can be provided as a retro-fit for existing vehicles. In such embodiment, a plurality of mounting brackets can be provided to mount the heater 111 and fan 112 to an existing vehicle.

In the event the existing vehicle is a gas powered car, such retrofit can provide advantages by warming up the engine. Cold starts increase engine wear and put unnecessary strain on the battery. By reducing fuel consumption and permitting a smooth engine start without the usual coughs and splutters and excessive exhaust fumes, a preheater saves plenty of time, trouble and money. Catalytic converters are also more efficient when the engine is warmed up in advance.

FIG. 2B is a block diagram showing high voltage control of a vehicle heater. A switch 154 is used to turn on or off the heating function. The switch 154 can be an ignition switch for the car, or can be a heater on/off switch. The switch 154 connects a low voltage power supply 148 to a relay 150. In this case, the low voltage power supply 148 is the car's 12V battery. The relay 150 is also connected to a high voltage power supply 158, in this case a 72V battery. The supply 158 can be other voltages such as 120V or 360V, among others. The high voltage power supply 158 is connected to a fuse 160 which in turn is connected to ground. Upon user command, the relay 150 gates the high voltage power output to the heater 111.

The heater relay/contractor 150 serves the purpose of a switch to close the circuit when the heater switch 148 is turned on. In one embodiment, the car ignition switch should be turned on for the heater to operate. However, in other embodiments, the heater can be turned on independent of the ignition switch. Instead of a switch with a rating of 120V between the main battery pack and the heater, the relay is included to control the 72V or 120V heater using the 12V side. The 12V coil side of the relay can be connected to the heater switch on the dashboard and the 72V or 120V side will be connected to the heater. In this manner, when the heater switch is turned on, the 12V side is energized inside the relay and closes the 72V or 120V side and heater will function. The relays/contactors are made by companies like Cole Hersee, White Rodgers, Stancor, Ametek, Prestolite, among others.

In one implementation, the heating system consists of a 72/120V heater, 12V fan, 12V switch, fuse, and a 12V relay as shown in the attachment. The 12V switch located on the dash is used to control the heater system on/off. The 12V switch in turn powers the heater fan and 12V relay leading to the 72V heater. As the 12V relay coil energizes in the relay the 72V switch closes activating the 72V heater.

The embodiment of FIG. 2B applies the entire battery voltage of the 72 volts battery, and can be upscalable to apply 120 volts or even 360 volts to the heater. By applying the high voltage supply to the heater, the heating system is more efficient and can provide more wattage for heating purposes. Due to the high voltage rail, the system keeps connecting wires to a minimal size to be cost-effective.

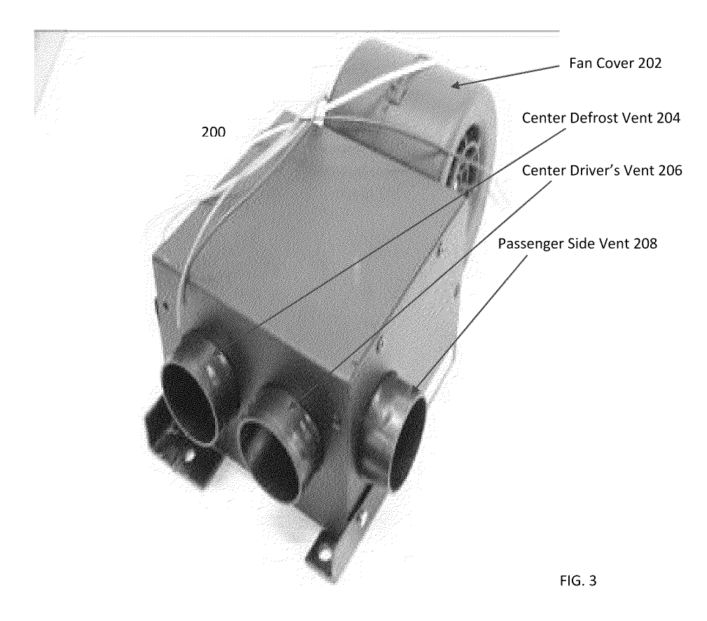

FIG. 3 shows an exemplary heater with housing 200 and cab duct outputs. The housing 200 includes a fan cover 202, a defrost vent 204, a driver vent 206 and a passenger vent 208. Vents 202-208 are connected to cab air ducts to heat the interior of the cab as well as defrost the wind shield.

The control circuit 108 can be a wired control using discrete components, or alternatively can be microcontroller based. During use, the heater coil serves to generate heat only during the receipt of a voltage. Mounted on a control panel of the vehicle is a temperature control dial for selecting a temperature. Associated therewith is an activation switch mounted on the control panel for transmitting an activation signal upon the depression thereof. Finally, control means, in form of the control circuitry is connected between the fan, heating element or heater coil, temperature control dial, and activation switch. In use, the control means transmits a predetermined voltage amount to both the fan and the heater coil only during the receipt of the activation signal. It should be noted that the predetermined voltage is proportional to the temperature selected by way of the temperature control dial. In a microcontroller implementation, the user selects the temperature control through a digital input such as a keypad or an analog input such as a touch screen that is digitized. The microcontroller interprets the user selection and generates the appropriate voltage to control the fan. Alternatively, if the fan is controlled by pulse widths, the microcontroller causes appropriate PWM signals to control the fan speed. The fan 112 in turn generates an amount of heat and air flow that are a function of the duty cycle of the pulses from the pulse width modulator.

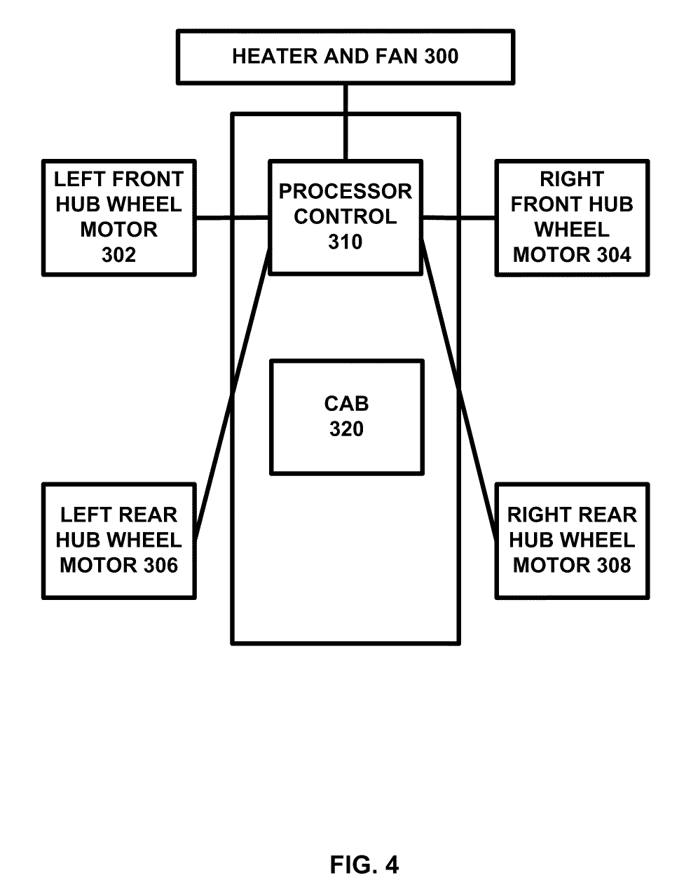

FIG. 4 shows an exemplary electric heater/fan 300 used in an electric vehicle with hub wheel motors 302-308. The motors 302-308 and the heater/fan 300 are controlled by a vehicle processor 310 to provide transportation to passengers located in a cab 320. The temperature of the cab 320 is controlled to provide environmental comfort to the passengers. The hub motor of FIG. 4 is designed to be small in size. The compact motor assembly is mounted in conjunction with the hub of the car. The motor assembly includes a self contained unit which includes a rotationally driven motor housing that is connected directly to the tire supporting rim of the car wheel. Rotation of the motor housing will result in similar rotation of the tire supporting rim of the wheel. The motor housing has an internal chamber and within that internal chamber is located a stator and a rotor. The stator is fixedly mounted onto a center shaft which passes through the motor housing which is fixedly mounted to the car. The rotor is to be rotated by the electrical energy being supplied to the stator with this rotation being transferred through the drive shaft.

The exemplary hub wheel motor system includes a motor enclosed by a hub cap and a tire supporting rim. A rubber wheel can be mounted on the rim. The back of the hub cap has an opening through which a cable is inserted therethrough to provide power as well as control signals to the motor. The motor has outer, ring-shaped permanent magnets (stator) that rotate while the inner metallic core (rotor) is fixed. When the motor is switched on, the static rotor stays still while the stator spins around it. A tire is attached to the motor, and as the outer part of the motor rotates, the wheel (or wheels) powers the vehicle forward.

Since the motors are hub-wheel motors, the independent heater/fan 300 can provide defrosting as well as heating capability to the cab to provide comfort to the vehicle occupants while they are using the vehicle.

The electric car with hub-wheel motors can be the Alias, available from ZAP, Inc. of Santa Rosa, Calif. The Alias is 100% electric, 100% of the time. Recharging is simple and effortless via any 110V outlet at home or on the road. The Alias has aerodynamic contours, low profile, wide stance with double-wishbone suspension, and sport styling. The vehicle can also be a truck with hub-wheel motors called ZAP Truck XL. Roomy, durable, rugged yet whisper quiet, the ZAPTRUCK XL is the affordable green solution for fleet operations. The electric truck is a utilitarian workhorse providing a roomy cab for two and a convertible bed/platform for moving up to 1600 lbs. of cargo during off-road use. The vehicle is ideal for corporate campuses, warehouses, universities, factories, municipal operations and around the ranch or farm.

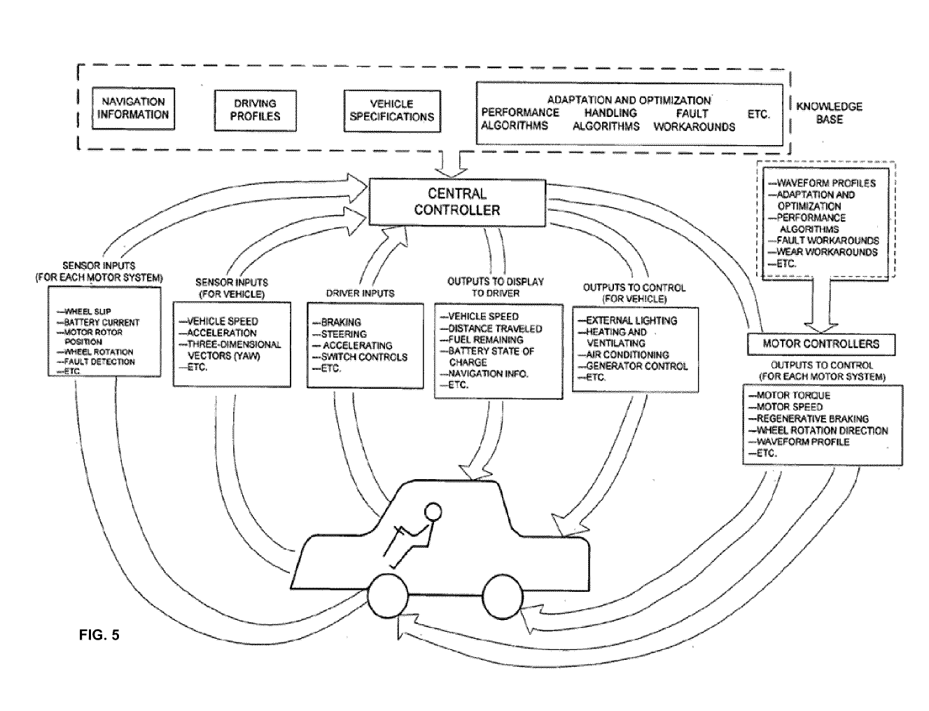

FIG. 5 shows an exemplary environmentally friendly vehicle control system. FIG. 5 shows how a central controller receives various inputs, draws on necessary information (driving profiles, vehicle specifications and navigation information), and produces the appropriate outputs. The central controller makes use of a range of inputs from sensors. The central controller combines this information with driver inputs received through a “user interface.” Typically, these driver inputs include braking, steering, accelerator and the various switch controls. The central controller can then combine these inputs with stored driving profiles, vehicle specifications, and navigation information. Based on all this information, the central controller optimizes for best performance. This requires sending control signals to the motors to continuously control motor torque and speed.

The system can preheat the cabin to normal operating temperature, de-mist and defrost the windows and preheat the car's interior, all with the engine switched off. In cold environments, the user can remotely turn on the heater to avoid scraping ice and struggling with steamed-up windows. The timer on the dashboard can be used program when the user wants the heater to start so that, by the time the user drives off, the windscreens and windows are thawed, the temperature inside is nice and warm and the engine is warmed up and ready to go. The system also enables the user to keep the temperature constant even when the electric hub wheel motor or engine is off due to traffic jam. The system enables driving in winter to be safer by preventing windows from steaming up and providing excellent all-round visibility.

In one embodiment, the central controller senses temperature conditions and issues a command to maintain constant temperature given the weather condition and the occupant's desired temperature range. The central controller linearly ramps down the fan when the temperature is too high and vice versa. The user, through the user interface, can override the processor when conditions change or for any reason. In this manner, the vehicle can increase its efficiency and user comfort while minimizing environmental pollution.

The software controlling the heater and fan 111/112 or 300 can be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The system has been described in terms of specific examples which are illustrative only and are not to be construed as limiting. In addition to control or embedded system software, the system may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. An electric vehicle, comprising:
a. a frame having a cab;
b. a plurality of hub wheel motors mounted to the frame, each hub wheel motor rotating a wheel; and
c. a heater and a fan thermally coupled to the cab, wherein the heater has an independent fuse to prevent a heater problem from shutting down the electric vehicle.

2. The vehicle of claim 1, comprising a defrost vent coupled to the fan.

3. The vehicle of claim 1, comprising a driver vent and a passenger vent coupled to the fan.

4. The vehicle of claim 1, wherein the heater is powered by a high voltage supply, comprising a relay controlled by a low voltage power supply to switch the high voltage power supply to the heater.

5. The vehicle of claim 1, comprising a battery voltage sensor.

6. The vehicle of claim 1, comprising a cabin temperature sensor or a battery sensor.

7. The vehicle of claim 1, wherein the fan is coupled to a main battery pack, an auxiliary battery pack, or a power converter.

8. The vehicle of claim 1, comprising a secondary battery coupled to the heater.

9. The vehicle of claim 1, comprising a solar cell coupled to the secondary battery and the heater.

10. The vehicle of claim 9, comprising a charger coupled to the secondary battery.

11. The vehicle of claim 1, wherein the heater comprises a heating element.

12. The vehicle of claim 11, wherein the heating element converts electricity into heat through Joule heating.

13. The vehicle of claim 11, wherein the heating elements comprises a Nichrome 80/20 (80% nickel, 20% chromium) wire, ribbon, or strip.

14. The vehicle of claim 11, wherein the heating element comprises a Positive Thermal Coefficient of resistance.

15. A method for operating an electric vehicle, comprising:
a. providing a plurality of hub wheel motors to a frame with a cab, each hub wheel motor rotating a wheel; and
b. heating the cab using an electric heater with an independent fuse to prevent a heater problem from shutting down the electric vehicle.

16. The method of claim 15, comprising defrosting a wind shield.

17. The method of claim 15, wherein the heater is powered by a high voltage supply, comprising switching with a relay the high voltage power supply to power the heater.

18. The method of claim 15, comprising a battery voltage sensor.

19. The method of claim 15, comprising adjusting the heater based on a cabin temperature sensor or a battery temperature sensor.

20. The method of claim 15, comprising powering the heater with a secondary battery or a solar cell.
